(19) United States
(12) Patent Application Publication
(10) Pub. No.: US 2013/0182767 A1
(43) Pub. Date: Jul. 18, 2013

(54) IDENTIFYING A KEY FRAME FROM A VIDEO SEQUENCE

(71) Applicants: Xiaohui Xie, Beijing (CN); Like Zhu, Beijing (CN); Kongqiao Wang, Beijing (CN); Yingfei Liu, Beijing (CN)

(72) Inventors: Xiaohui Xie, Beijing (CN); Like Zhu, Beijing (CN); Kongqiao Wang, Beijing (CN); Yingfei Liu, Beijing (CN)

(73) Assignee: NOKIA CORPORATION, Espoo (FI)

(21) Appl. No.: 13/825,185

(22) PCT Filed: Sep. 20, 2010
(86) PCT No.: PCT/CN2010/077139

§ 371 Date: Mar. 20, 2013

(51) Int. Cl. H04N 7/26

(52) U.S. Cl. CPC H04N 19/00569
USPC 375/240.13

(57) ABSTRACT

An example apparatus is caused to receive a video sequence of a plurality of frames, and activate one of a plurality of available decoding processes based on a comparison of a size of the frames to a predefined threshold. The apparatus is also caused to select some but not all of the frames of the video sequence as potential key frames of the video sequence. The selected frames are located at or close to predefined positions along a length of the video sequence. The apparatus is also caused to decode the potential key frames according to the activated decoding process, and cause output of at least some of the potential key frames as key frames of the video sequence. The apparatus may be caused to discard from the potential key frames, one or more plain frames and/or a frame identified as being similar to other potential key frames.

### TECHNICAL FIELD

The present invention generally relates to browsing video sequences and, more particularly, relates to identifying a key frame from a video sequence to facilitate browsing of video sequences based on their respective key frames.

### BACKGROUND

As mobile data storage increases and camera-imaging quality improves, users are increasingly capturing and sharing video with their mobile devices. One major drawback of the increasing use of video, however, arises while browsing a graphical user interface for a desired video clip or sequence. Video summarization is a family of techniques for creating a summary of a video sequence including one or more scenes each of which includes one or more frames. The summary may take any of a number of different forms, and in various instances, may include cutting a video sequence at the scene level or frame level. In the context of cutting a video at the scene level, a video summary may be presented, for example, as a video skim including some scenes but cutting other scenes. In the context of cutting a video at the frame level, a video summary may be presented, for example, as a fast-forward function of key frames of the video sequence, or as a still or animated storyboard of one or more key frames or thumbnails of one or more key frames. A summary of a video sequence may facilitate a user identifying a desired video sequence from among a number of similar summaries of other video sequences. Further, a summary may facilitate more efficient memory recall of a video sequence since the user may more readily identify a desired video.

Although a number of video summarization techniques have been developed, it is generally desirable to improve upon existing techniques.

### BRIEF SUMMARY

In light of the foregoing background, example embodiments of the present invention provide an improved apparatus, method and computer-readable storage medium for identifying one or more key frames of a video sequence including a plurality of frames. One aspect of example embodiments of the present invention is directed to an apparatus including at least one processor and at least one memory including computer program code. The memory/memories and computer program code are configured to, with processor(s), cause the apparatus to at least perform a number of operations.

The apparatus is caused to receive a video sequence of a plurality of frames, each of which may include one or more pictures. The apparatus is caused to activate one of a plurality of available decoding processes based on a comparison of a size of the frames to a predefined threshold, such as a first predefined threshold. The apparatus is also caused to select some but not all of the frames of the video sequence as potential key frames of the video sequence, such as by selecting at least some intra-coded frames but not inter-coded frames with which the intra-coded frames are interspersed. The selected frames are located at or close to predefined positions along a length of the video sequence, where the predefined positions are separated from one another by an increment interval of more than one frame. The apparatus is also caused to decode the potential key frames according to the activated decoding process, and cause output of at least some of the potential key frames as key frames of the video sequence.

The memory/memories and computer program code being configured to, with processor(s), cause the apparatus to cause output of at least some of the potential key frames as key frames may include being configured to cause the apparatus to identify a potential key frame as a plain frame, discard the plain frame from the potential key frames, and cause output of at least some of the potential key frames but not the discarded plain frame as key frames of the video sequence. The potential key frame may be identified as a plain frame based on a value of one or more properties of a picture of the potential key frame, where the one or more properties include one or more of an entropy, histogram or edge point detection. In this regard, the apparatus being caused to identify a potential key frame as a plain frame may include the apparatus being caused to calculate a filter score for a potential key frame as a function of values of the entropy, histogram and edge point detection of the potential key frame, and identify the potential key frame as a plain frame in an instance in which the filter score is at or below a second predefined threshold. More particularly, for example, the apparatus being caused to calculate a filter score may include the apparatus being caused to calculate a weighted sum of values of two or more of the entropy, histogram or edge point detection of the potential key frame.

In addition to or in lieu of identifying and discarding a plain frame from the potential key frames, the apparatus being caused to cause output of at least some of the potential key frames as key frames may include the apparatus being caused to identify a potential key frame as being similar to a reference key frame. The respective potential key frame may be identified based on a value of one or more properties of a picture of the potential key frame, where the one or more properties include one or more of a block histogram, color histogram or order sequence. Also in this instance, the apparatus may be caused to discard the identified potential key frame from the potential key frames, and cause output of at least some of the potential key frames but not the discarded, identified frame as key frames of the video sequence.

In a more particular example, the apparatus being caused identify a potential key frame as being similar to a reference key frame may include the apparatus being caused to calculate one or more values representative of a comparison of a value of one or more properties of a picture of the potential key frame to a corresponding value of one or more properties of a picture of a reference key frame. Also in this instance, the apparatus may be caused to calculate a discriminator score for the potential key frame as a function of the one or more values representative of the comparison, and identify the potential key frame as being similar to the reference key frame in an instance in which the filter score is at or below a third predefined threshold.

The value(s) representative of the comparison may include an absolute difference between a histogram mean value of the potential key frame and a corresponding histogram mean value of the reference key frame. The value(s) may additionally or alternatively include an absolute difference between a color histogram mean value of the potential key frame and a corresponding color histogram mean value of the reference key frame.

The value(s) representative of the comparison may additionally or alternatively include an order sequence comparison as a function of an order sequence of blocks of the potential key frame and a corresponding order sequence of blocks of the reference key frame. In one particular example of being caused to calculate an order sequence comparison, the apparatus may be caused to calculate an order sequence of blocks of the potential key frame and a corresponding order sequence of blocks of the reference key frame. In one example, the apparatus being caused to calculate the order sequence for each frame may include the apparatus being caused to rank blocks of the frame according to block histogram mean values of the respective blocks, order the rankings of the blocks in an order of the blocks of the picture, and concatenate to the ordering a repeated ordering of the rankings of the blocks. A longest common subsequence between the order sequence of the potential key frame and the order sequence of the reference key frame may then be calculated, and a staircase function may be applied to the longest common subsequence to calculate the order sequence comparison.

In the foregoing instances, the apparatus being caused to calculate a discriminator score may include the apparatus being caused to calculate a weighted sum of values of two or more of the values. That is, the apparatus may be caused to calculate a weighted sum of values of two or more of the absolute difference between the histogram mean values of the potential key frame and reference key frame, the absolute difference between the color histogram mean values of the potential key frame and reference key frame, or the order sequence comparison.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system, in accordance with example embodiments of the present invention;

FIG. 2 is a schematic block diagram of the apparatus of the system of FIG. 1, in accordance with example embodiments of the present invention;

FIG. 3 is a functional block diagram of the apparatus of FIG. 2, in accordance with example embodiments of the present invention;

FIG. 4 is a flowchart illustrating various operations in a method of adaptive decoding, according to example embodiments of the present invention;

FIG. 5 is a flowchart illustrating various operations in a method of plain frame filtering, according to example embodiments of the present invention;

FIGS. 6a and 6b are flowcharts illustrating various operations in a method of key frame discriminating and comparing, according to example embodiments of the present invention;

FIG. 7 illustrates an example of splitting a frame picture into a plurality of blocks, according to example embodiments of the present invention;

FIG. 8 illustrates an example of calculating an order sequence and longest common subsequence (LCS) of a number of sequences, according to example embodiments of the present invention; and

FIG. 9 illustrates a gradual changing issue during adjacent frame comparison.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. Reference may be made herein to terms specific to a particular system, architecture or the like, but it should be understood that example embodiments of the present invention may be equally applicable to other similar systems, architectures or the like. For instance, example embodiments of the present invention may be shown and described herein in the context of ad-hoc networks; but it should be understood that example embodiments of the present invention may be equally applied in other types of distributed networks, such as grid computing, pervasive computing, ubiquitous computing, peer-to-peer, cloud computing for Web service or the like.

The terms “data,” “content,” “information,” and similar terms may be used interchangeably, according to some example embodiments of the present invention, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Further, as used herein, the term “circuitry” refers to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory/memories that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Further, as described herein, various messages or other communication may be transmitted or otherwise sent from one component or apparatus to another component or apparatus. It should be understood that transmitting a message or other communication may include not only transmission of the message or other communication, but may also include preparation of the message or other communication by a transmitting apparatus or various means of the transmitting apparatus.

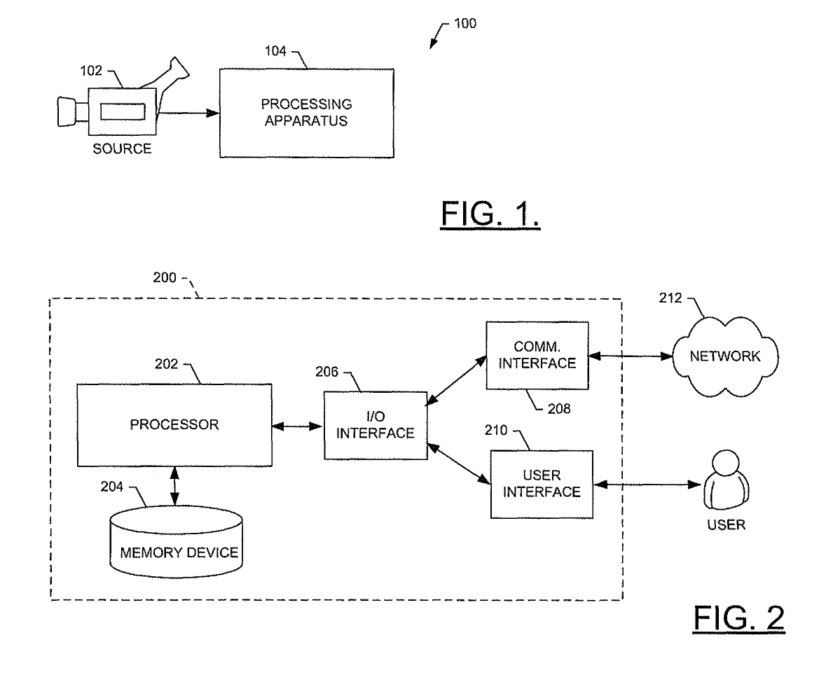

Referring to FIG. 1, an illustration of one system that may benefit from the present invention is provided. The system, method and computer program product of exemplary embodiments of the present invention will be primarily described without respect to the environment within which the system, method and computer program product operate. It should be understood, however, that the system, method and computer program product may operate in a number of different environments, including mobile and/or fixed environments, wireline and/or wireless environments, standalone and/or networked environments or the like. For example, the system, method and computer program product of exemplary embodiments of the present invention can operate in mobile communication environments whereby mobile terminals operating within one or more mobile networks include or are otherwise in communication with one or more sources of video sequences.

The system 100 includes a video source 102 and a processing apparatus 104. Although shown as separate components, it should be understood that in some embodiments, a single apparatus may support both the video source and processing apparatus, logically separated but co-located within the respective entity. For example, a mobile terminal may support a logically separate, but co-located, video source and processing apparatus. Irrespective of the manner of implementing the system, however, the video source can comprise any of a number of different components capable of providing one or more sequences of video. Like the video source, the processing apparatus can comprise any of a number of different components configured to process video sequences from the video source according to example embodiments of the present invention. Each sequence of video provided by the video source may include a plurality of frames, each of which may include an image, picture, slice or the like (generally referred to as “picture”) of a shot or scene (generally referred to as a “scene”) that may or may not depict one or more objects. The sequence may include different types of frames, such as intra-coded frames (I-frames) that may be interspersed with inter-coded frames such as predicted picture frames (P-frames) and/or bi-predictive picture frames (B-frames).

The video source 102 can include, for example, an image capture device (e.g., video camera), a video cassette recorder (VCR), digital versatile disc (DVD) player, a video file stored in memory or downloaded from a network, or the like. In this regard, the video source can be configured to provide one or more video sequences in a number of different formats including, for example, Third Generation Platform (3GP), AVI (Audio Video Interleave), Windows Media®, MPEG (Moving Pictures Expert Group), QuickTime®, RealVideo®, Shockwave® (Flash®) or the like.

Reference is now made to FIG. 2, which illustrates an apparatus 200 that may be configured to function as the processing apparatus 104 to perform example methods of the present invention. In some example embodiments, the apparatus may, be embodied as, or included as a component of, a communications device with wired or wireless communications capabilities. The example apparatus may include or otherwise be in communication with one or more processors 202, memory devices 204, Input/Output (I/O) interfaces 206, communications interfaces 208 and/or user interfaces 210 (one of each being shown).

The processor 202 may be embodied as various means for implementing the various functionalities of example embodiments of the present invention including, for example, one or more of a microprocessor, a coprocessor, a controller, a special-purpose integrated circuit such as, for example, an ASIC (application specific integrated circuit), an FPGA (field programmable gate array), DSP (digital signal processor), or a hardware accelerator, processing circuitry or other similar hardware. According to one example embodiment, the processor may be representative of a plurality of processors, or one or more multi-core processors, operating individually or in concert. A multi-core processor enables multiprocessing within a single physical package. Examples of a multi-core processor include two, four, eight, or greater numbers of processing cores. Further, the processor may be comprised of a plurality of transistors, logic gates, a clock (e.g., oscillator), other circuitry, and the like to facilitate performance of the functionality described herein. The processor may, but need not, include one or more accompanying digital signal processors (DSPs). A DSP may, for example, be configured to process real-world signals in real time independent of the processor. Similarly, an accompanying ASIC may, for example, be configured to perform specialized functions not easily performed by a more general purpose processor. In some example embodiments, the processor is configured to execute instructions stored in the memory device or instructions otherwise accessible to the processor. The processor may be configured to operate such that the processor causes the apparatus to perform various functionalities described herein.

Whether configured as hardware alone or via instructions stored on a computer-readable storage medium, or by a combination thereof, the processor 202 may be an apparatus configured to perform operations according to embodiments of the present invention while configured accordingly. Thus, in example embodiments where the processor is embodied as, or is part of, an ASIC, FPGA, or the like, the processor is specifically configured hardware for conducting the operations described herein. Alternatively, in example embodiments where the processor is embodied as an executor of instructions stored on a computer-readable storage medium, the instructions specifically configure the processor to perform the algorithms and operations described herein. In some example embodiments, the processor is a processor of a specific device configured for employing example embodiments of the present invention by further configuration of the processor via executed instructions for performing the algorithms, methods, and operations described herein.

The memory device 204 may be one or more computer-readable storage media that may include volatile and/or non-volatile memory. In some example embodiments, the memory device includes Random Access Memory (RAM) including dynamic and/or static RAM, on-chip or off-chip cache memory, and/or the like. Further, the memory device may include non-volatile memory, which may be embedded and/or removable, and may include, for example, Read-Only Memory (ROM), flash memory, magnetic storage devices (e.g., hard disks, floppy disk drives, magnetic tape, etc.), optical disc drives and/or media, non-volatile random access memory (NVRAM), and/or the like. The memory device may include a cache area for temporary storage of data. In this regard, at least a portion or the entire memory device may be included within the processor 202.

Further, the memory device 204 may be configured to store information, data, applications, computer-readable program code instructions, and/or the like for enabling the processor 202 and the example apparatus 200 to carry out various functions in accordance with example embodiments of the present invention described herein. For example, the memory device may be configured to buffer input data for processing by the processor. Additionally, or alternatively, the memory device may be configured to store instructions for execution by the processor. The memory may be securely protected, with the integrity of the data stored therein being ensured. In this regard, data access may be checked with authentication and authorized based on access control policies.

The I/O interface 206 may be any device, circuitry, or means embodied in hardware, software or a combination of hardware and software that is configured to interface the processor 202 with other circuitry or devices, such as the communications interface 208 and/or the user interface 210. In some example embodiments, the processor may interface with the memory device via the I/O interface. The I/O interface may be configured to convert signals and data into a form that may be interpreted by the processor. The I/O interface may also perform buffering of inputs and outputs to support the operation of the processor. According to some example embodiments, the processor and the I/O interface may be combined onto a single chip or integrated circuit configured to perform, or cause the apparatus 200 to perform, various functionalities of an example embodiment of the present invention.

The communication interface 208 may be any device or means embodied in hardware, software or a combination of hardware and software that is configured to receive and/or transmit data from/to one or more networks 212 and/or any other device or module in communication with the example apparatus 200. The processor 202 may also be configured to facilitate communications via the communications interface by, for example, controlling hardware included within the communications interface. In this regard, the communication interface may include, for example, one or more antennas, a transmitter, a receiver, a transceiver and/or supporting hardware, including, for example, a processor for enabling communications. Via the communication interface, the example apparatus may communicate with various other network elements in a device-to-device fashion and/or via indirect communications.

The communications interface 208 may be configured to provide for communications in accordance with any of a number of wired or wireless communication standards. The communications interface may be configured to support communications in multiple antenna environments, such as multiple input multiple output (MIMO) environments. Further, the communications interface may be configured to support orthogonal frequency division multiplexed (OFDM) signaling. In some example embodiments, the communications interface may be configured to communicate in accordance with various techniques including, as explained above, any of a number of second generation (2G), third generation (3G), fourth generation (4G) or higher generation mobile communication technologies, radio frequency (RF), infrared data association (IrDA) or any of a number of different wireless networking techniques. The communications interface may also be configured to support communications at the network layer, possibly via Internet Protocol (IP).

The user interface 210 may be in communication with the processor 202 to receive user input via the user interface and/or to present output to a user as, for example, audible, visual, mechanical or other output indications. The user interface may include, for example, a keyboard, a mouse, a joystick, a display (e.g., a touch screen display), a microphone, a speaker, or other input/output mechanisms. Further, the processor may comprise, or be in communication with, user interface circuitry configured to control at least some functions of one or more elements of the user interface. The processor and/or user interface circuitry may be configured to control one or more functions of one or more elements of the user interface through computer program instructions (e.g., software and/or firmware) stored on a memory accessible to the processor (e.g., the memory device 204). In some example embodiments, the user interface circuitry is configured to facilitate user control of at least some functions of the apparatus 200 through the use of a display and configured to respond to user inputs. The processor may also comprise, or be in communication with, display circuitry configured to display at least a portion of a user interface, the display and the display circuitry configured to facilitate user control of at least some functions of the apparatus.

In some cases, the apparatus 200 of example embodiments may be implemented on a chip or chip set. In an example embodiment, the chip or chip set may be programmed to perform one or more operations of one or more methods as described herein and may include, for instance, one or more processors 202, memory devices 204, I/O interfaces 206 and/or other circuitry components incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip or chip set can be implemented in a single chip. It is further contemplated that in certain embodiments the chip or chip set can be implemented as a single “system on a chip.” It is further contemplated that in certain embodiments a separate ASIC may not be used, for example, and that all relevant operations as disclosed herein may be performed by a processor or processors. A chip or chip set, or a portion thereof, may constitute a means for performing one or more operations of one or more methods as described herein.

In one example embodiment, the chip or chip set includes a communication mechanism, such as a bus, for passing information among the components of the chip or chip set. In accordance with one example embodiment, the processor 202 has connectivity to the bus to execute instructions and process information stored in, for example, the memory device 204. In instances in which the apparatus 200 includes multiple processors, the processors may be configured to operate in tandem via the bus to enable independent execution of instructions, pipelining, and multithreading. In one example embodiment, the chip or chip set includes merely one or more processors and software and/or firmware supporting and/or relating to and/or for the one or more processors.

As explained in the background section, video summarization is a family of techniques for creating a summary of a video sequence including one or more scenes each of which includes one or more frames. Example embodiments of the present invention provide a technique for identifying one or more key frames of a plurality of frames of a video sequence. These key frame(s) may then be used in a number of different manners to provide a user with a flexible manipulation to the video sequence, such as for fast browsing tagging, summarization or the like.

As explained below in accordance with the technique of example embodiments of the present invention, video frames may be adaptively selected and decoded, and video length and/or resolution may be taken into consideration according to an expectation of the video key-frame number. The technique of example embodiments may additionally or alternatively fuse mean gray and variance values, entropy values and/or edge point detection values to filter plain frames such as blank, simple color or simple pattern frames. Further, for example, the technique may include an integration framework of block histogram of mean gray and variance values, differences of block color histogram, edge point detection values and/or longest common subsequence of block mean values. The technique may provide a feature for discrimination of video frames and/or longest common subsequence of block mean values, which may be robust to object moving and rotation. And the technique may employ frame selection in a manner that is robust to gradual changing frames.

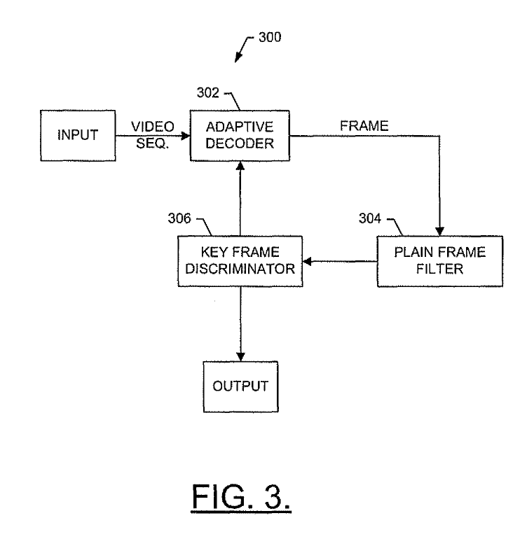

Reference is now made to FIG. 3, which illustrates a functional block diagram of an apparatus 300 that may be configured to function as the processing apparatus 104 to perform example methods of the present invention. Generally, and as explained in greater detail below, the apparatus may be configured to receive a video sequence, such as in the form of a video media file or live video stream. The apparatus may be configured to analyze the video sequence to identify one or more key frames of the video sequence, and output the identified key frame(s).

The apparatus 300 may include a number of modules, including an adaptive decoder 302, plain frame filter 304 and/or key frame discriminator 306, each of which may be implemented by various means. These means may include, for example, the processor 202, memory device 204, I/O interface 206, communication interface 208 (e.g., transmitter, antenna, etc.) and/or user interface 210, alone or under direction of one or more computer program code instructions, program instructions or executable computer-readable program code instructions from a computer-readable storage medium (e.g., memory device).

As explained in greater detail below, the adaptive decoder 302 may be configured to adaptively decode frames of a video sequence or the DC coefficients of such frames. The plain frame filter 304 may be configured to filter frames that are devoid of any picture, or that include a simple pattern or blurred picture. And the key frame discriminator 306 may be configured to discard frames that exceed a threshold similarity, and process representative frames from a filtered result list. Although the apparatus 300 may include all of the adaptive decoder, plain frame filter and key frame discriminator that perform respective operations described below, it should be understood that the apparatus may not include either or both of the plain frame filter and frame discriminator. In such instances, the adaptive decoder may identify and output key frames (as opposed to potential key frames) of the video sequence.

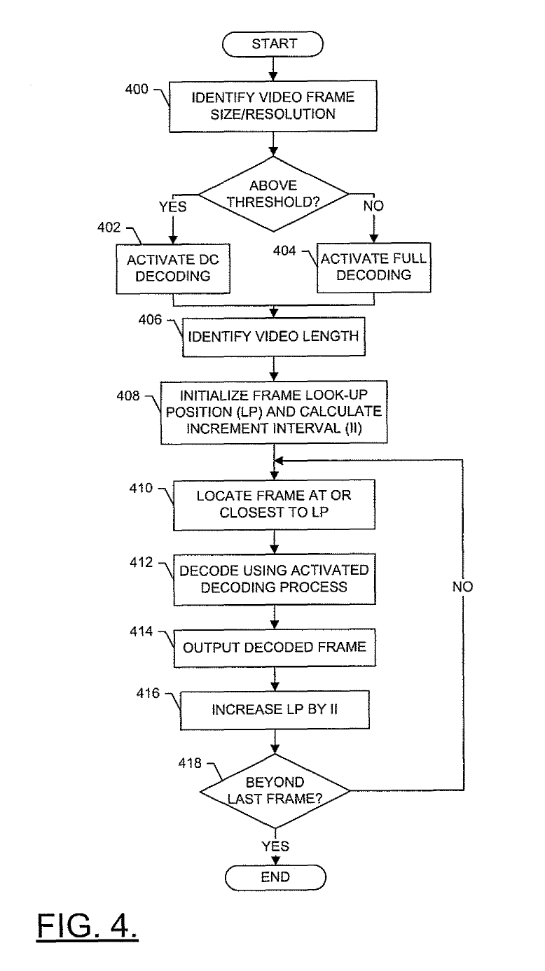

FIG. 4 is a flowchart illustrating various operations in a method of adaptive decoding that may be performed by various means of the processing apparatus 104, such as by the adaptive decoder 302 of apparatus 300, according to example embodiments of the present invention. Generally, the method may include adaptive decoding frames of a video sequence based on properties of the video including the resolution or size (generally referred to as the “size”) of the frames of the video and the number of frames in the video. In this regard, to process the video sequence with increased efficiency, in various instances, the adaptive decoding may be of spatially-reduced versions of the frames instead of the original frames, where these spatially-reduced versions may have a size a fraction of the original frames (e.g., ¼, ⅛). These spatially-reduced versions are oftentimes referred to as DC images, each of which is formed of DC coefficients. Effective decoding the DC coefficients of the frame instead of the original frame, however, may be dependent upon the size of the frames.

Relative to the size of the frames of the video, the method may include comparing the size of the frames of a video sequence to a predefined threshold, as shown in block 400. In an instance in which the frame size is above the predefined threshold, a DC decoding process may be activated, as shown at block 402; otherwise, in an instance in which the size is equal to or below the threshold, a full decoding process may be activated, as shown at block 404. In this manner, the method may apply different decoding processes to different video sequences with frames that have different sizes/resolutions.

The predefined threshold to which the size of the frames is compared may be selected in a number of different manners. In one example embodiment, the plain frame filter 304 and/or key frame discriminator 306 may be configured to process decoded frames of a given size. In this example embodiment, the predefined threshold may be set to at least the given size divided by the fraction of the size of the DC images relative to their corresponding original frames (e.g., ¼, ⅛).

Relative to the number of frames in the video, the method may account for decoding computation consumption and complexity by selecting a subset of the frames including some but less than all of the frames in the video, and identifying one or more key frames only from this subset (the frames in the subset being potential key frames). The potential key frames may be selected in any of a number of different manners. In various example embodiments, the potential key frames may be selected as frames located at or close to predefined positions along the length of the video sequence, where the positions may be separated from one another by an increment interval (II) of more than one frame (or otherwise reflects more than one frame). The positions along and length of the video sequence may be defined in a number of different manners, such as in terms of time or number of frames.

More particularly, for example, the method may include identifying the length of the video, as shown in block 406; and include initializing a frame look-up position (LP) and calculating an increment interval, as shown in block 408. Similar to the positions along and length of the video sequence, the look-up position and increment interval may be defined in a number of different manners, such as in terms of time or number of frames.

The look-up position may be initialized to any of a number of different values, such as to time zero or the first frame of the video sequence. Similarly, the increment interval may be set or otherwise calculated in a number of different manners. Generally, for a lower increment interval, more potential key frames may be selected; and for a higher the increment interval, fewer potential key frames may be selected. In one example, the increment interval may be calculated from a desired number of key frames. The desired number of key frames may be set arbitrarily or based on one or more parameters such as the length of the video sequence, and the frequency of the video changing shots/scenes which in various instances may be marked by I-frames. For example, considering a 1200 second video sequence that changes shots/scenes at a frequency of 60 seconds, the desired number of key frames may be set to 20 (i.e., 1200/60). The increment interval, then, may be set to an interval that produces a number of potential key frames equal to at least the desired number of key frames (e.g., at least 60 seconds).

To account for the plain frame filter 304 and/or key frame discriminator 306 filtering out one or more potential key frames, the increment interval may be set to an interval that produces a greater number of potential key frames than the desired number of key frames. The number of potential key frames filtered out by the plain frame filter and/or key frame discriminator may be varied as a function of their parameters (e.g., thresholds); and thus, a number of potential key frames anticipated to be filtered out may be estimated from the respective parameters. The increment interval may be set to an interval that produces a number of potential key frames equal to at least the sum of the desired number of key frames and the number of potential key frames anticipated to be filtered out. In one example, consider a video includes 1000 shot/scene changes that may be marked by 10001-frames, and in which the desired number of key frames is 20. In this example, the increment interval may be set to 10 frames so that 100 potential key frames may be output from the adaptive decoder 302 to facilitate production of approximately 20 key frames after the potential key frames are passed through the plain frame filter and/or key frame discriminator.

After initializing the frame look-up position, the method may include locating a frame at or closest to the respective position in the video sequence, as shown at block 410. In various example embodiments, the method may by performed with even further reduced complexity by selecting only frames of a particular type (e.g., I-frames) as potential key frames. In such example embodiments, the method may more particularly include locating a frame of the particular type at or closest to the frame look-up position. The method may then include decoding the located frame using the activated decoding process (DC decoding or full decoding), as shown at block 412. The decoded frame may then be output as a potential key frame, such as to the plain frame filter 304 or key frame discriminator 306, as shown in block 414.

Also after decoding the located frame, the method may include increasing the look-up position by the increment interval, as shown in block 416. The incremented look-up position may be compared to the last frame of the video sequence, as shown in block 418. This comparison may include, for example, comparing an incremented look-up time to the time of the video or comparing an incremented look-up frame number to the number of the last frame of the video. In an instance in which the incremented look-up position is beyond the last frame of the video sequence, the adaptive decoding method may end for the video sequence. Otherwise, in an instance in which the incremented look-up position is not beyond the last frame of the video sequence, the adaptive decoding method may repeat by locating the frame at or closest to the look-up position (block 410), decoding the located frame (block 412), outputting the decoded frame (block 414) and incrementing the look-up position by the increment interval (block 416). The process may continue until the incremented look-up position is beyond the last frame of the video sequence. In this manner, the method of adaptive decoding (as well as the below methods of plain frame filtering and key frame discriminating and comparing) may decode a video sequence as frames of the sequence are received, and need not first receive the entire video sequence.

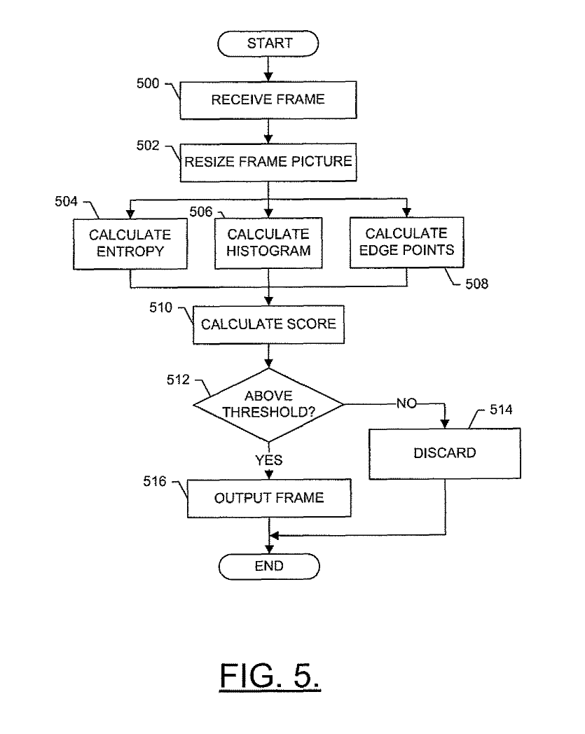

FIG. 5 is a flowchart illustrating various operations in a method of plain frame filtering that may be performed by various means of the processing apparatus 104, such as by the plain frame filter 304 of apparatus 300, according to example embodiments of the present invention. Generally, the method may include filtering out of the potential key frames (subset of the frames of the video sequence) plain frames such as blank, simple color or simple pattern frames, which may be identified based on properties of picture(s) of the respective frames. These properties may include, for example, the entropy, histogram and/or edge point detection values of the picture(s).

As shown, the method may include receiving a decoded frame of a video sequence, such as from the adaptive decoder 302, as shown in block 500; and if so desired, may include resizing a picture of the frame, as shown in block 502. Regardless of whether a picture of the frame is resited, the method may include calculating values of one or more properties of the picture, such as values of the entropy, histogram and/or edge point detection values of the picture, as shown in blocks 504, 506 and 508.

The entropy (block 504) of a picture generally represents the degree of organization of information within the picture. The entropy I of a picture may be calculated in accordance with the following:

$$I = - {\sum }_{g} {p}_{g} log {p}_{g}$$

where g represents a gray value of a plurality of gray values (e.g., 0-255), and p_{g} represents the probability of any pixel of the picture having the gth gray value. In this regard, the gray value of a pixel may be considered a value proportional to the intensity of the pixel (e.g., 0-255).

The histogram (block 506) of a picture may represent different numbers of pixels having the same intensity values. The histogram of a picture may be calculated by grouping the pixels (e.g., gray-scaled pixels) of the picture with the same intensity value, and representing the number of same-valued pixels versus their respective intensity values. Statistical properties of the picture, such as its mean μ and variance σ, may then be calculated from the histogram, such as in accordance with the following (assuming the histogram obeys a Gaussian distribution):

$$μ = \frac{\sum i \times H ( i )}{\sum H ( i )} , σ = \frac{1}{w \times h - 1} {\sum }_{x , y} [ μ - {p}_{x , y} ]$$

In the preceding, H(i) represents the sum of the number of pixels within the picture having an intensity i, producing a histogram height of intensity I. Also, the variables w and h represent width and height of the picture (in pixels), and mᵤ represents the intensity of pixel (x, y).

Calculating edge point detection values (block 508) in the picture may be performed in accordance with an edge point detection technique. Generally, an edge may define a boundary in a picture, and may be considered a point or pixel in the picture at which the intensity of the picture exhibits a sharp change (discontinuity). Edge detection may be useful to determine whether a picture depicts an object. One suitable edge detection technique that may be employed in example embodiments of the present invention is the Roberts' Cross operator, which may be represented as follows:

E_{R(x,y)}=|p_{x,y}−p_{x+1,y+1}|+|p_{x+1,y}−p_{x,y+1}|

where E_{R(x,y)} represents a gradient magnitude and, again, p_{x,y} represents the intensity of pixel (x, y). A statistical value E_{R} (edge point detection value) representative of the number of edge points that exceed a threshold Th_E_{R}, then, may be calculated as follows:

E_{R}=card(E_{q(x,y)}|E_{R(x,y)}>Th_{—}E_{R})

After calculating the entropy I, histogram statistics μ, σ and gradient magnitude statistic E_{R}, a filter score S_{filter} may be calculated from the calculated values of the respective properties of the picture, as shown in block 510. In one example embodiment, the filter score may be calculated as a weighted sum of the values of the properties, such as in accordance with the following:

S_{filter}=I×w_{entropy}+E_{R}×w_{edge}+μ×wₘₑₐₙ+σ×wᵥₐᵣ

In the preceding, W_{entropy}, w_{edge}, wₘₑₐₙ and wᵥₐᵣ represent weight coefficients. These coefficients may be selected in a number of different manners, and in one example embodiment, are subject to the condition W_{entropy}+W_{edge}+Wₘₑₐₙ+wᵥₐᵣ=1.

After calculating the filter score S_{filter}, the method may include comparing the filter score to a predefined threshold, as shown in block 512. In an instance in which the filter score is at or below the predefined threshold, the frame may be identified as a plain frame and discarded, as shown in block 514. Otherwise, as shown in block 516, in an instance in which the filter score is above the predefined threshold, the frame may be output such as from the plain frame filter 304 to the key frame discriminator 306.

It should be understood that in various instances all of the frames of a video sequence may be identified as plain frames (filter score S_{filter} at or below the appropriate threshold). To account for such instances, example embodiments may employ a leave one strategy in which a discarded frame having the highest filter score is maintained in memory. Then, in an instance in which the plain frame filter 304 detects that all of the frames of a video sequence have been identified as plain frames, the plain frame filter may output the frame having the highest score filter.

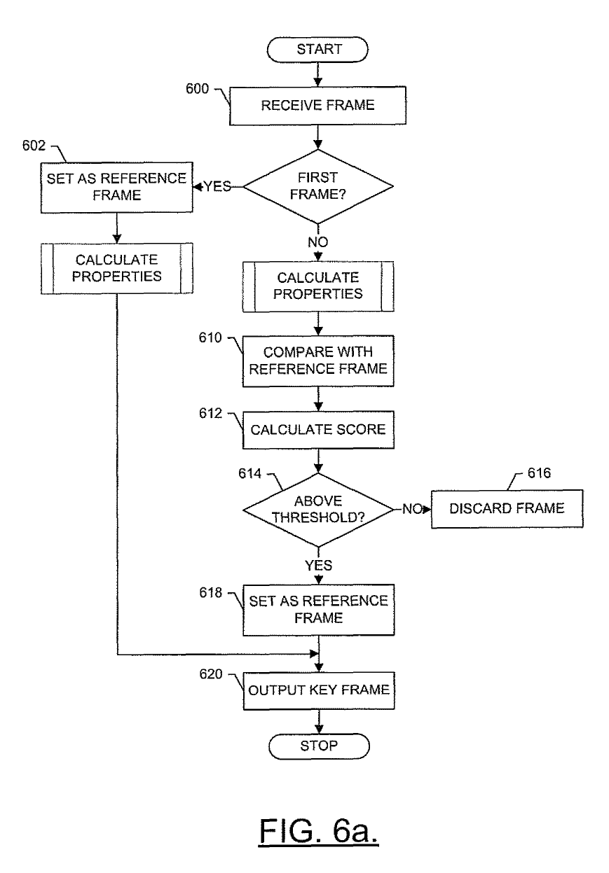

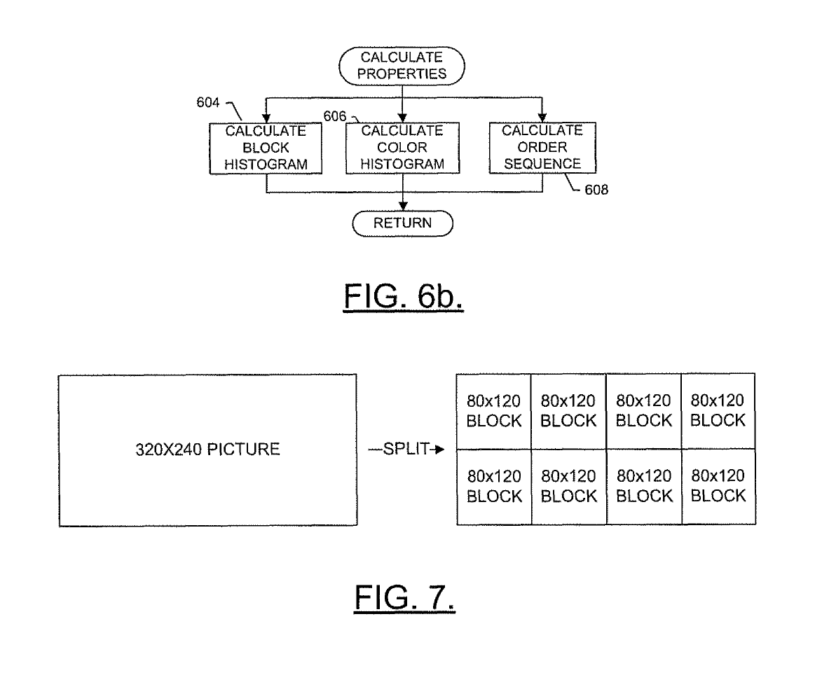

FIGS. 6a and 6b (individually or collectively “FIG. 6”) are flowcharts illustrating various operations in a method of key frame discriminating and comparing that may be performed by various means of the processing apparatus 104, such as by the key frame discriminator 306 of apparatus 300, according to example embodiments of the present invention. Generally, the method may include identifying and filtering out various potential key frames similar to other various potential key frames in visual content, and otherwise outputting the potential key frames as key frames of the video sequence.

As shown, the method may include receiving a decoded frame of a video sequence, such as from the plain frame filter 304, as shown in block 600 of FIG. 6a. In an instance in which the frame is the first received frame, the method may include setting the frame as a reference frame, as shown in block 602. Regardless of whether the frame is the first frame, though, the method may include calculating values of one or more properties of a picture of the frame from which the similarity of the frame to another frame may be judged. These properties may include, for example, a block histogram, color histogram and order sequence, their respective calculations being shown in blocks 604, 606 and 608 of FIG. 6b.

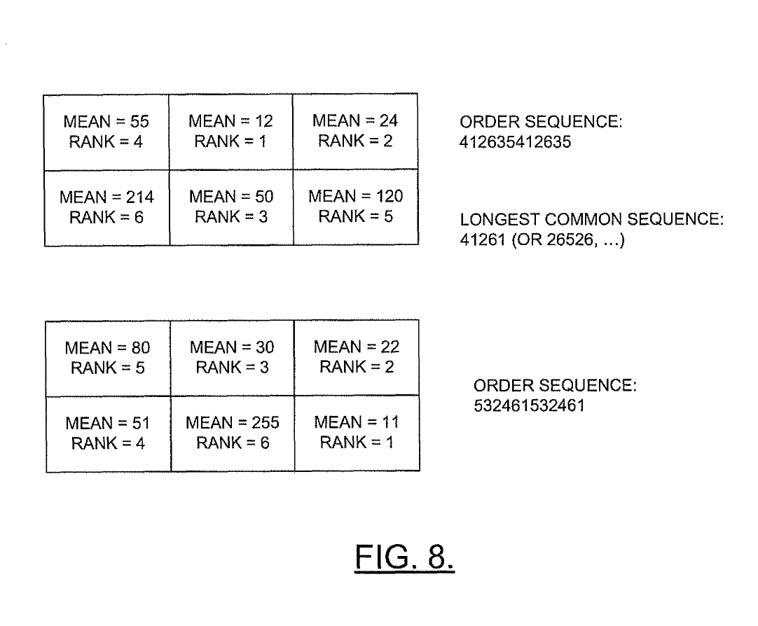

The block histogram (block 604) of a frame picture may be generated by splitting the picture into a fixed number of equal smaller blocks, and calculating the histogram and statistical properties (e.g., mean and variance a) for each block, such as in a manner similar to that described above (block 506). An example manner by which a picture may be split is shown in FIG. 7 in which a picture having 320×240 pixels may be split into eight blocks that each have 80×120 pixels.

The color histogram (block 606) of a frame picture is generally a representation of the distribution of colors in the picture, and may be generated by quantizing each pixel of the picture according to its red R, green G and blue B component colors. Statistical properties (e.g., mean μ and variance σ) of the color histogram for the picture may then be calculated, such as in a manner similar to that described above. In one example embodiment, each component color R, G, B of a pixel (x, y) may be represented by a byte of data:

R_{x,y}=(R₈_{_{x,y}}R₇_{_{x,y}}R₆_{_{x,y}}R₅_{_{x,y}}R₄_{_{x,y}}R₃_{_{x,y}}R₂_{_{x,y}}R₁_{_{x,y}})

G_{x,y}=(G₈_{_{x,y}}G₇_{_{x,y}}G₆_{_{x,y}}G₅_{_{x,y}}G₄_{_{x,y}}G₃_{_{x,y}}G₂_{_{x,y}}G₁_{_{x,y}})

B_{x,y}=(B₈_{_{x,y}}B₇_{_{x,y}}B₆_{_{x,y}}B₅_{_{x,y}}B₄_{_{x,y}}B₃_{_{x,y}}B₂_{_{x,y}}B₁_{_{x,y}})

In this example embodiment, the color histogram value for the pixel may be calculated by quantizing the pixel according to the following:

C_{x,y}=(R>>2)&0x30+(G>>2)&0x0C+(B>>6)&0x03

In the preceding, in binary form, 0x30 is 00110000, 0x0C is 00001100, 0x03 is 00000011. R>>2 yields (0 0 R₈ R₇ R₆ R₅ R₄ R₃); and so, (R>>2) & 0x30 may be computed as follows:

$$\& \begin{matrix}0 & 0 & {R}_{8} & {R}_{7} & {R}_{6} & {R}_{5} & {R}_{4} & {R}_{3} \\ 0 & 0 & 1 & 1 & 0 & 0 & 0 & 0 \\ 0 & 0 & {R}_{8} & {R}_{7} & 0 & 0 & 0 & 0\end{matrix} \begin{matrix}( R >> 2 ) \\ ( 0 \times 30 )\end{matrix}$$

(G>>2) & 0x0C and (B>>6) & 0x03 may be calculated in the same manner. Thus, when added together, C_{x,y} may be represented as follows:

C_{x,y}=(0 0R₈R₇0 0 0 0)+(0 0 0 0G₈G₇0 0)+(0 0 0 0 0 0B₈B₇)=(0 0R₈R₇G₈G₇G₈B₇)

This equation combines the high two bits of each component color into a single byte, such as in the following manner: C_{x,y}=(0 0 R₈_{_{x,y}}R₇_{_{x,y}}G₈_{_{x,y}}G₇_{_{x,y}}B₇_{_{x,y}})₂. The statistical properties for the color histogram may then be calculated from the quantized values C_{x,y} across the pixels of the picture.

Calculating the order sequence (block 608) of a frame picture may utilize the block-histogram calculated smaller blocks and histogram statistical properties for each block. For example, the blocks of the picture may be ranked according to their mean values p, such as from the block with the lowest mean to the block with the highest mean. This is shown in FIG. 8 for the pictures of two frames. In the example of FIG. 8, the pictures each include six blocks that may be ranked from 1 to 6 according to their respective mean values from the lowest mean value to the highest mean value. For the top picture shown in the figure, the blocks having mean values of 12 and 214 may be assigned the ranks of 1 and 6, respectively; and for the bottom picture, the blocks having mean values of 11 and 255 may be assigned the ranks of 1 and 6, respectively. The remaining blocks of the pictures may be similarly assigned rankings of 2-5 according to their respective mean values.

The order sequence may then be calculated by ordering the rankings of the blocks in the order of the blocks in the picture, such as from left-to-right, top-to-bottom; and concatenating to the ordering a repeated ordering of the rankings of the blocks. Returning to the example of FIG. 8, from left-to-right, top-to-bottom, the rankings of the blocks of the top picture may be ordered and repeated as follows: 412635412635. Similarly, the rankings of the blocks of the bottom picture may be ordered and repeated as follows: 532461532461.

Before, as or after calculating the properties of the picture of a frame, in an instance in which the frame is the first received frame, the method may include outputting the first/reference frame as a key frame of the video sequence, as shown in block 620. As indicated above, this and other key frames of the video sequence may then be used in a number of different manners to provide a user with a flexible manipulation to the video sequence, such as for fast browsing, tagging, summarization or the like. The method may then end and await receipt of another frame (potential key frame) (block 600)—the properties for the first/reference frame being recorded for subsequent use in analyzing at least the next received frame.

For a frame other than the first frame, the method may include comparing the values of the properties of the frame with corresponding values of the properties of the reference frame (initially the first frame), and calculating one or more values representative of the comparison so as to facilitate a determination of whether the frame is similar to the reference frame, as shown in block 610. The comparison values between a frame and reference frame may include the absolute difference between the histogram mean values of the frame and reference frame, diff-mean, which for each frame, may be received from the plain frame filter 304 (block 506) or calculated from the means of the blocks of the frame (block 604). The comparison values may additionally or alternatively include the absolute difference between the color histogram mean values of the frame and reference frame, diff-color-mean, for each frame.

The comparison values may additionally or alternatively include an order sequence comparison, order-seq, between the frame and reference frame. The order sequence comparison may be calculated by calculating a longest common subsequence (LCS) between the order sequences of the frame and reference frame (block 608), and applying a staircase function to the LCS. The LCS for a first sequence X=(x₁, x₂, . . . xₘ) and second sequence Y=(y₁, y₂, . . . yₙ) may be calculated as follows:

$$LCS ( {X}_{i} , {Y}_{j} ) = \{ \begin{matrix} 0 & if i = 0 or j = 0 \\ ( LCS ( {X}_{i - 1} , {Y}_{j - 1} ) , {x}_{i} ) & if {x}_{i} = {y}_{i} \\ longest ( LCS ( {X}_{i} , {Y}_{j - 1} ) , LCS ( {X}_{i - 1} , {Y}_{j} ) ) & if {x}_{i} \neq {y}_{i}\end{matrix}$$

In the preceding, LCS (Xi, Yⱼ) represents the set of longest common subsequence of prefixes Xᵢ and Yⱼ. An example of the LCS between two order sequences is shown, for example, in FIG. 8.

After calculating the values representing the comparison between a frame and reference frame, the method may include calculating a discriminator score S_{discriminator} for the frame from the respective values, as shown in block 612. In one example embodiment, the discriminator score may be calculated as a weighted sum of the comparison values, such as in accordance with the following:

S_{discriminator}=diff-mean×w_{diff-mean}+diff-color-mean×w_{diff-color-mean}+w_{order-seq}=1.

In the preceding, W_{diff-mean}, W_{diff-color-mean} and W_{order-seg} represent weight coefficients. These coefficients may be selected in a number of different manners, and in one example embodiment, are subject to the condition: w_{diff-mean}+W_{diff-color-mean}+W_{order-seq}=1.

After calculating the discriminator score S_{discriminator}, the method may include comparing the discriminator score to a predefined threshold, as shown in block 614. In an instance in which the discriminator score is at or below the predefined threshold, the frame may be identified as being similar to the reference frame and discarded, as shown in block 616. Otherwise, as shown in block 618, in an instance in which the discriminator score is above the predefined threshold, the frame may be set as the reference frame for subsequent use in analyzing at least the next received frame. Additionally, as shown in block 620, the frame may be output as a key frame of the video sequence, which may be in a number of different manners such as for fast browsing, tagging, summarization or the like.

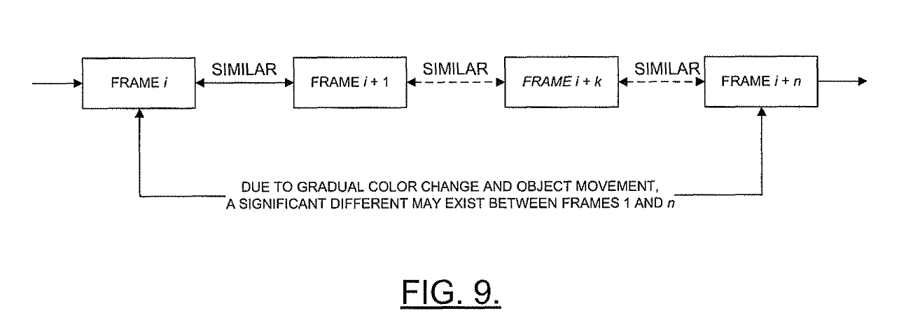

The introduction of the reference frame and the process of comparison of the frame with other potential key frames may avoid comparison between adjacent frames, which may present a gradual changing issue as shown in FIG. 9. As shown in FIG. 9, due to small differences between adjacent frames, frame i may be judged similar to frame i+1, which may be judged similar to frame i+k, which may be judged similar to frame i+n. But by aggregating the small differences across the frames, a more significant different may exist between frame i and frame i+n.

The method of example embodiments may also reduce memory usage by utilizing the pictures of just two frames (reference frame and frame being compared to it) in any given instance. Also, the properties of the pictures that are calculated may be computationally efficient, and the comparison between two frames may be convenient, thereby resulting in a relatively fast discrimination and comparison process.

According to one aspect of the example embodiments of present invention, functions performed by the processing apparatus 104, apparatus 200 and/or apparatus 300, such as those illustrated by the flowcharts of FIGS. 4-6, may be performed by various means. It will be understood that each block or operation of the flowcharts, and/or combinations of blocks or operations in the flowcharts, can be implemented by various means. Means for implementing the blocks or operations of the flowcharts, combinations of the blocks or operations in the flowcharts, or other functionality of example embodiments of the present invention described herein may include hardware, alone or under direction of one or more computer program code instructions, program instructions or executable computer-readable program code instructions from a computer-readable storage medium. In this regard, program code instructions may be stored on a memory device, such as the memory device 204 of the example apparatus, and executed by a processor, such as the processor 202 of the example apparatus. As will be appreciated, any such program code instructions may be loaded onto a computer or other programmable apparatus (e.g., processor, memory device, or the like) from a computer-readable storage medium to produce a particular machine, such that the particular machine becomes a means for implementing the functions specified in the flowcharts' block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the flowcharts' block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the flowcharts' block(s) or operation(s).

Accordingly, execution of instructions associated with the blocks or operations of the flowcharts by a processor, or storage of instructions associated with the blocks or operations of the flowcharts in a computer-readable storage medium, supports combinations of operations for performing the specified functions. It will also be understood that one or more blocks or operations of the flowcharts, and combinations of blocks or operations in the flowcharts, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1. An apparatus comprising:
at least one processor; and
at least one memory including computer program code,
the at least one memory and the computer program code configured to, with the at least one processor, cause the apparatus to at least:
receive a video sequence of a plurality of frames;
activate one of a plurality of available decoding processes based on a comparison of a size of the frames to a predefined threshold;
select some but not all of the frames of the video sequence as potential key frames of the video sequence, the selected frames being located at or close to predefined positions along a length of the video sequence, the predefined positions being separated from one another by an increment interval of more than one frame;
decode the potential key frames according to the activated decoding process; and
cause output of at least some of the potential key frames as key frames of the video sequence.

2. The apparatus according to claim 1, wherein the video sequence includes intra-coded frames interspersed with inter-coded frames, and wherein being configured to cause the apparatus to select some but not all of the frames includes being configured to cause the apparatus to select at least some of the intra-coded frames but none of the inter-coded frames.

3. The apparatus according to claim 1, wherein each frame includes one or more pictures, and wherein being configured to cause the apparatus to cause output of at least some of the potential key frames as key frames includes being configured to cause the apparatus to:
identify a potential key frame as a plain frame based on a value of one or more properties of a picture of the potential key frame, the one or more properties including one or more of an entropy, histogram or edge point detection;
discard the plain frame from the potential key frames; and
cause output of at least some of the potential key frames but not the discarded plain frame as key frames of the video sequence.

4. The apparatus according to claim 3, wherein the predefined threshold to which the size of the frames is compared is a first predefined threshold, and wherein being configured to cause the apparatus to identify a potential key frame as a plain frame includes being configured to cause the apparatus to:
calculate a filter score for a potential key frame as a function of values of the entropy, histogram and edge point detection of the potential key frame; and
identify the potential key frame as a plain frame in an instance in which the filter score is at or below a second predefined threshold.

5. The apparatus according to claim 4, wherein being configured to cause the apparatus to calculate a filter score includes being configured to cause the apparatus to calculate a weighted sum of values of two or more of the entropy, histogram or edge point detection of the potential key frame.

6. The apparatus according to claim 1, wherein being configured to cause the apparatus to cause output of at least some of the potential key frames as key frames includes being configured to cause the apparatus to:
identify a potential key frame as being similar to a reference key frame, the respective potential key frame being identified based on a value of one or more properties of a picture of the potential key frame, the one or more properties including one or more of a block histogram, color histogram or order sequence;
discard the identified potential key frame from the potential key frames; and
cause output of at least some of the potential key frames but not the discarded, identified frame as key frames of the video sequence.

7. The apparatus according to claim 6, wherein the predefined threshold to which the size of the frames is compared is a first predefined threshold, and wherein being configured to cause the apparatus to identify a potential key frame as being similar to a reference key frame includes being configured to cause the apparatus to:
calculate one or more values representative of a comparison of a value of one or more properties of a picture of the potential key frame to a corresponding value of one or more properties of a picture of a reference key frame;
calculate a discriminator score for the potential key frame as a function of the one or more values representative of the comparison; and
identify the potential key frame as being similar to the reference key frame in an instance in which the filter score is at or below a third predefined threshold.

8. The apparatus according to claim 7, wherein being configured to cause the apparatus to calculate one or more values representative of a comparison includes being configured to cause the apparatus to one or more of:
calculate an absolute difference between a histogram mean value of the potential key frame and a corresponding histogram mean value of the reference key frame;
calculate an absolute difference between a color histogram mean value of the potential key frame and a corresponding color histogram mean value of the reference key frame; or
calculate an order sequence comparison as a function of an order sequence of blocks of the potential key frame and a corresponding order sequence of blocks of the reference key frame, the picture of each of the potential key frame and reference key frame being foamed of a plurality of blocks.

9. The apparatus according to claim 8, wherein being configured to cause the apparatus to calculate an order sequence comparison includes being configured to cause the apparatus to:
calculate an order sequence of blocks of the potential key frame and a corresponding order sequence of blocks of the reference key frame, where being configured to cause the apparatus to calculate the order sequence for each frame includes being configured to cause the apparatus to:
rank blocks of the frame according to block histogram mean values of the respective blocks;
order the rankings of the blocks in an order of the blocks of the picture; and
concatenate to the ordering a repeated ordering of the rankings of the blocks;
calculate a longest common subsequence between the order sequence of the potential key frame and the order sequence of the reference key frame; and
apply a staircase function to the longest common subsequence to calculate the order sequence comparison.

10. The apparatus according to claim 8, wherein being configured to cause the apparatus to calculate a discriminator score includes being configured to cause the apparatus to calculate a weighted sum of values of two or more of the absolute difference between the histogram mean values of the potential key frame and reference key frame, the absolute difference between the color histogram mean values of the potential key frame and reference key frame, or the order sequence comparison.

11. An apparatus comprising:
means for receiving a video sequence of a plurality of frames;
means for activating one of a plurality of available decoding processes based on a comparison of a size of the frames to a predefined threshold;
means for selecting some but not all of the frames of the video sequence as potential key frames of the video sequence, the selected frames being located at or close to predefined positions along a length of the video sequence, the predefined positions being separated from one another by an increment interval of more than one frame;
means for decoding the potential key frames according to the activated decoding process; and
means for causing output of at least some of the potential key frames as key frames of the video sequence.

12-20. (canceled)

21. A method comprising:
receiving a video sequence of a plurality of frames;
activating one of a plurality of available decoding processes based on a comparison of a size of the frames to a predefined threshold;
selecting some but not all of the frames of the video sequence as potential key frames of the video sequence, the selected frames being located at or close to predefined positions along a length of the video sequence, the predefined positions being separated from one another by an increment interval of more than one frame;
decoding the potential key frames according to the activated decoding process; and
causing output of at least some of the potential key frames as key frames of the video sequence.

22. The method according to claim 21, wherein the video sequence includes intra-coded frames interspersed with inter-coded frames, and wherein selecting some but not all of the frames includes selecting at least some of the intra-coded frames but none of the inter-coded frames.

23. The method according to claim 21, wherein each frame includes one or more pictures, and wherein causing output of at least some of the potential key frames as key frames includes:
identifying a potential key frame as a plain frame based on a value of one or more properties of a picture of the potential key frame, the one or more properties including one or more of an entropy, histogram or edge point detection;
discarding the plain frame from the potential key frames; and
causing output of at least some of the potential key frames but not the discarded plain frame as key frames of the video sequence.

24. The method according to claim 23, wherein the predefined threshold to which the size of the frames is compared is a first predefined threshold, and wherein identifying a potential key frame as a plain frame includes:
calculating a filter score for a potential key frame as a function of values of the entropy, histogram and edge point detection of the potential key frame; and
identifying the potential key frame as a plain frame in an instance in which the filter score is at or below a second predefined threshold.

25. The method according to claim 24, wherein calculating a filter score includes calculating a weighted sum of values of two or more of the entropy, histogram or edge point detection of the potential key frame.

26. The method according to claim 21, wherein causing output of at least some of the potential key frames as key frames includes:
identifying a potential key frame as being similar to a reference key frame, the respective potential key frame being identified based on a value of one or more properties of a picture of the potential key frame, the one or more properties including one or more of a block histogram, color histogram or order sequence;
discarding the identified potential key frame from the potential key frames; and
causing output of at least some of the potential key frames but not the discarded, identified frame as key frames of the video sequence.

27. The method according to claim 26, wherein the predefined threshold to which the size of the frames is compared is a first predefined threshold, and wherein identifying a potential key frame as being similar to a reference key frame includes:
calculating one or more values representative of a comparison of a value of one or more properties of a picture of the potential key frame to a corresponding value of one or more properties of a picture of a reference key frame;
calculating a discriminator score for the potential key frame as a function of the one or more values representative of the comparison; and
identifying the potential key frame as being similar to the reference key frame in an instance in which the filter score is at or below a third predefined threshold.

28. The method according to claim 27, wherein calculating one or more values representative of a comparison includes one or more of:
calculating an absolute difference between a histogram mean value of the potential key frame and a corresponding histogram mean value of the reference key frame;
calculating an absolute difference between a color histogram mean value of the potential key frame and a corresponding color histogram mean value of the reference key frame; or
calculating an order sequence comparison as a function of an order sequence of blocks of the potential key frame and a corresponding order sequence of blocks of the reference key frame, the picture of each of the potential key frame and reference key frame being formed of a plurality of blocks.

29-30. (canceled)

31. A computer-readable storage medium having computer-readable program code portions stored therein, the computer-readable storage medium and computer-readable program code portions being configured to, with at least one processor, cause an apparatus to at least:
receive a video sequence of a plurality of frames;
activate one of a plurality of available decoding processes based on a comparison of a size of the frames to a predefined threshold;
select some but not all of the frames of the video sequence as potential key frames of the video sequence, the selected frames being located at or close to predefined positions along a length of the video sequence, the predefined positions being separated from one another by an increment interval of more than one frame;
decode the potential key frames according to the activated decoding process; and
cause output of at least some of the potential key frames as key frames of the video sequence.

32-40. (canceled)
